(19) United States
(12) Patent Application Publication
(10) Pub. No.: US 2026/0200390 A1
(43) Pub. Date: Jul. 16, 2026

(54) TRUCK RAMP SUPPORT DEVICE

(71) Applicant: Luke Fogg, JR., Salem, NJ (US)

(72) Inventor: Luke Fogg, JR., Salem, NJ (US)

(21) Appl. No.: 19/437,032

(22) Filed: Dec. 30, 2025

Related U.S. Application Data
(60) Provisional application No. 63/741,623, filed on Jan. 3, 2025.

(51) Int. Cl. B60P 1/43

(52) U.S. Cl. CPC B60P 1/435

(57) ABSTRACT

A truck ramp support device is useful to support truck ramps generally associated with trucks having cargo areas. The support device may comprise a pair of elongated members which have two general portions, a post member portion which is removably securable by suitable means at the rear of the truck and a ramp flange which extends from the upper end of the post member portions, and has a support area to engage an opposing portion of the truck ramp.

### FIELD

This disclosure related, generally, to ramps for trucks and, more particularly, to a support for truck ramps.

### BACKGROUND

Although ramps for the cargo areas of trucks are currently supported by various support and attachment mechanisms, the current art suffers from various drawbacks and disadvantages.

### SUMMARY

In one implementation, a support for a truck ramp can be used with truck ramps that are moveable by a truck driver or other user personnel between a stowed position and a deployed position. The support may be selectively engageable with a truck ramp that has a forward end securable to a rear portion of the truck. The ramp is engaged by the support so that the ramp is positioned to facilitate access to the floor of a truck cargo area.

In certain implementations, the truck ramp support makes use of a pair of elongated members. These members are shaped or otherwise configured so that they can engage an opposing, forward end of the truck ramp positioned adjacent to the entrance to the corresponding truck cargo area. Each of the elongated members in this implementation has a post member and a ramp flange. The post member has upper and lower ends. The ramp flange is located at the upper end of the post member. The ramp flange extends so as to create respective support areas which engage the forward end of the ramp when the ramp is deployed. The post members have respective engagement portions. Each of the engagement portions engages the rear of the truck at a location proximate to the cargo area.

In another possible implementation, the ramp flanges are slidably mounted to respective post members so that they can be secured between two positions: an extended position above the upper end of the post member and a retracted position below the upper end of the post member. In the extended position, the ramp flanges engage corresponding locations on the ramp when the ramp is deployed.

### DRAWINGS

FIG. 1 is a photo showing a suitable rear end of a truck with two brackets located to receive the truck ramp supports of the present invention.

FIG. 2 is a bottom view of a prior art truck ramp illustrating one of the drawbacks of prior art designs.

FIG. 3 is a photograph of a pair of elongated members according to one implementation.

FIG. 4 is a cross-sectional view of one of the elongated members of FIG. 3 shown engaged at the rear end of the truck.

FIGS. 5-8 are various views of one of the elongated members of the implementation shown in FIG. 3.

FIG. 9 is a photograph of another possible implementation of a truck ramp support according to the present invention, in which the ramp flange is movable between a stowed and a deployed position.

### DESCRIPTION

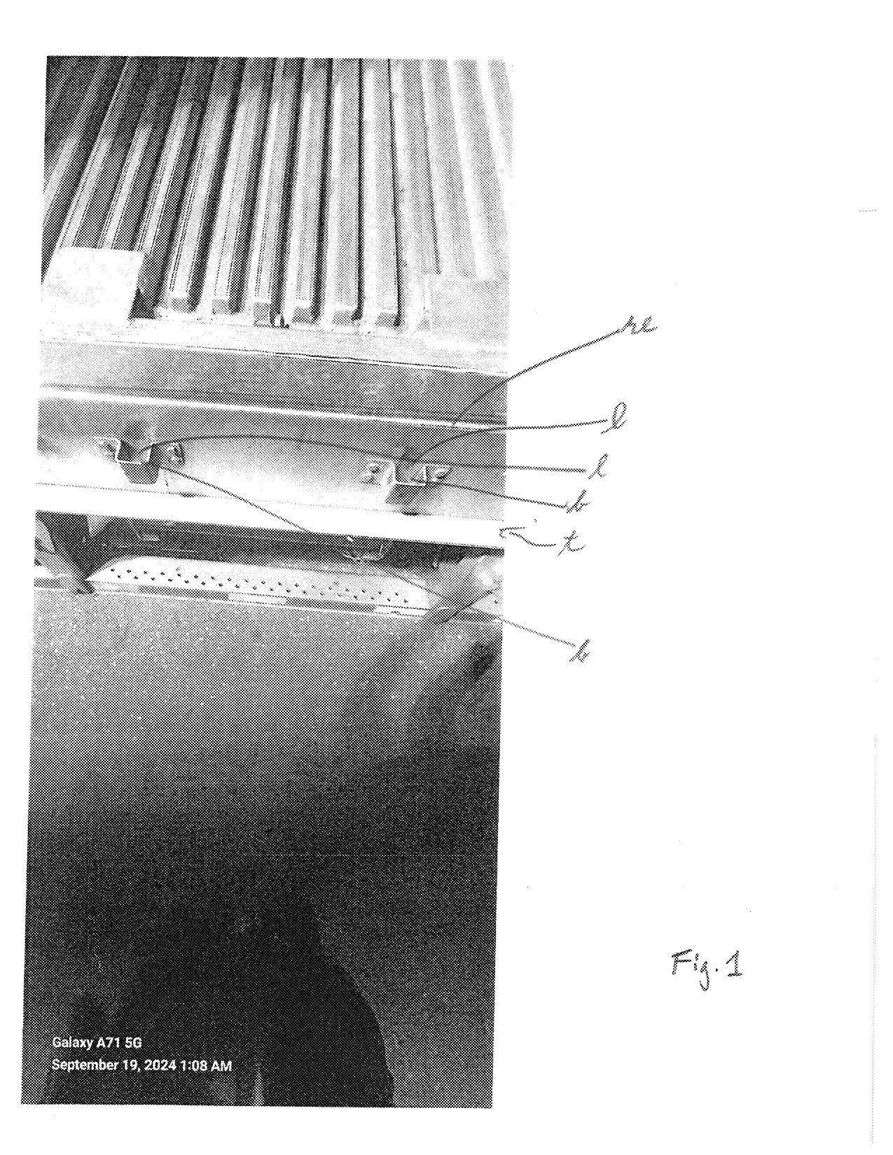

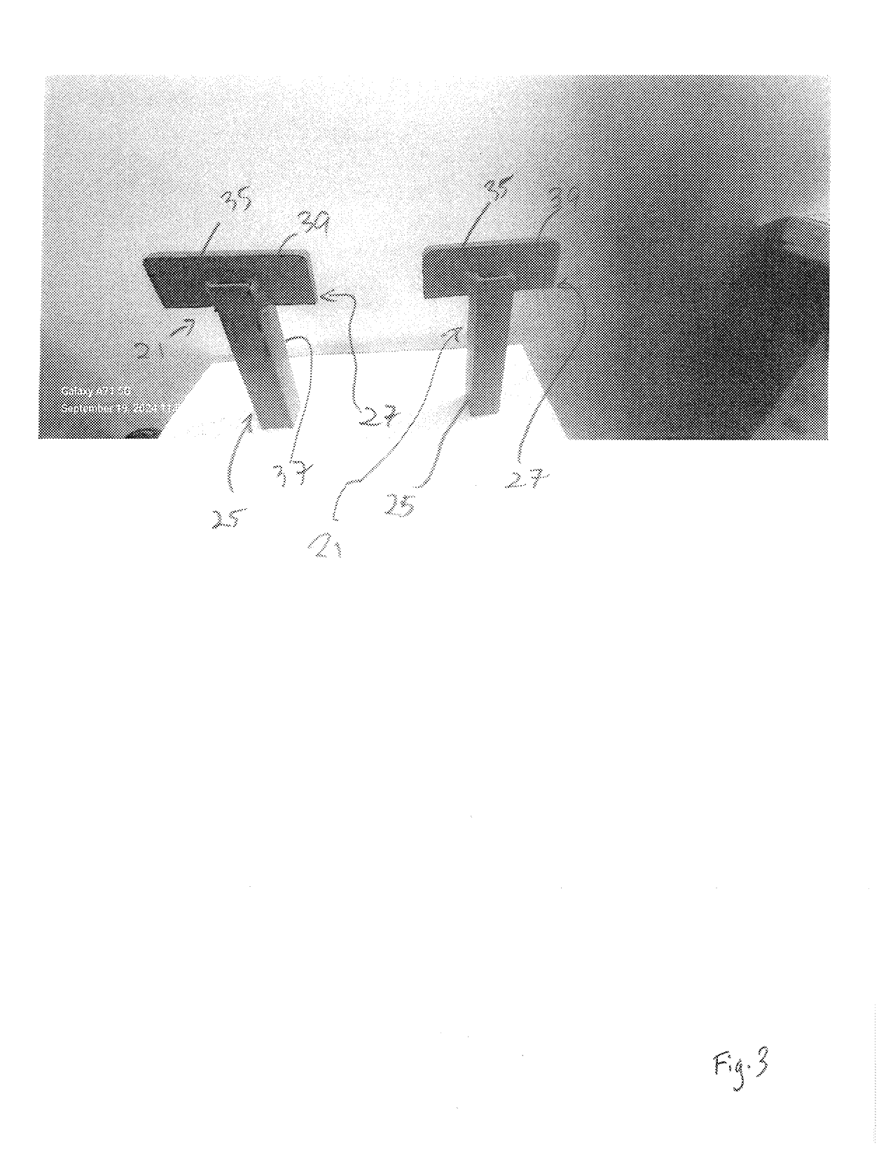

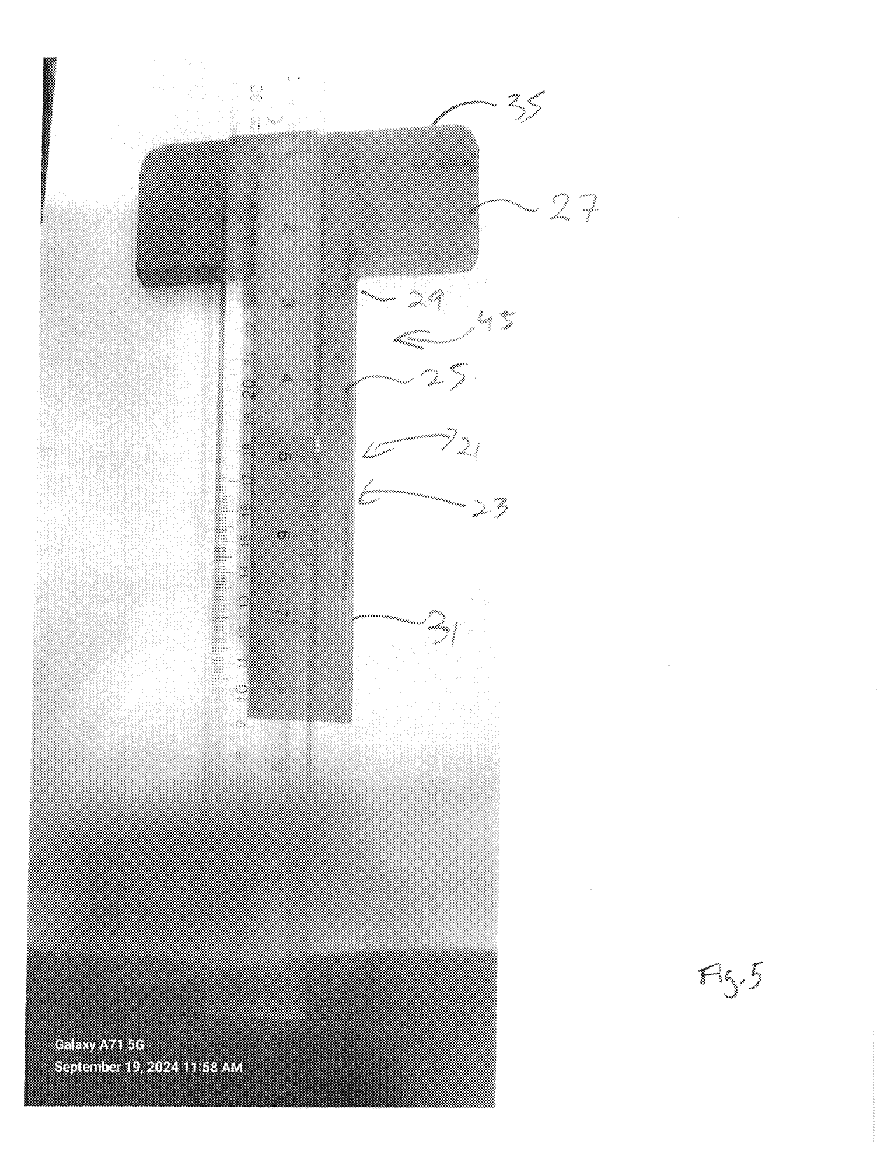

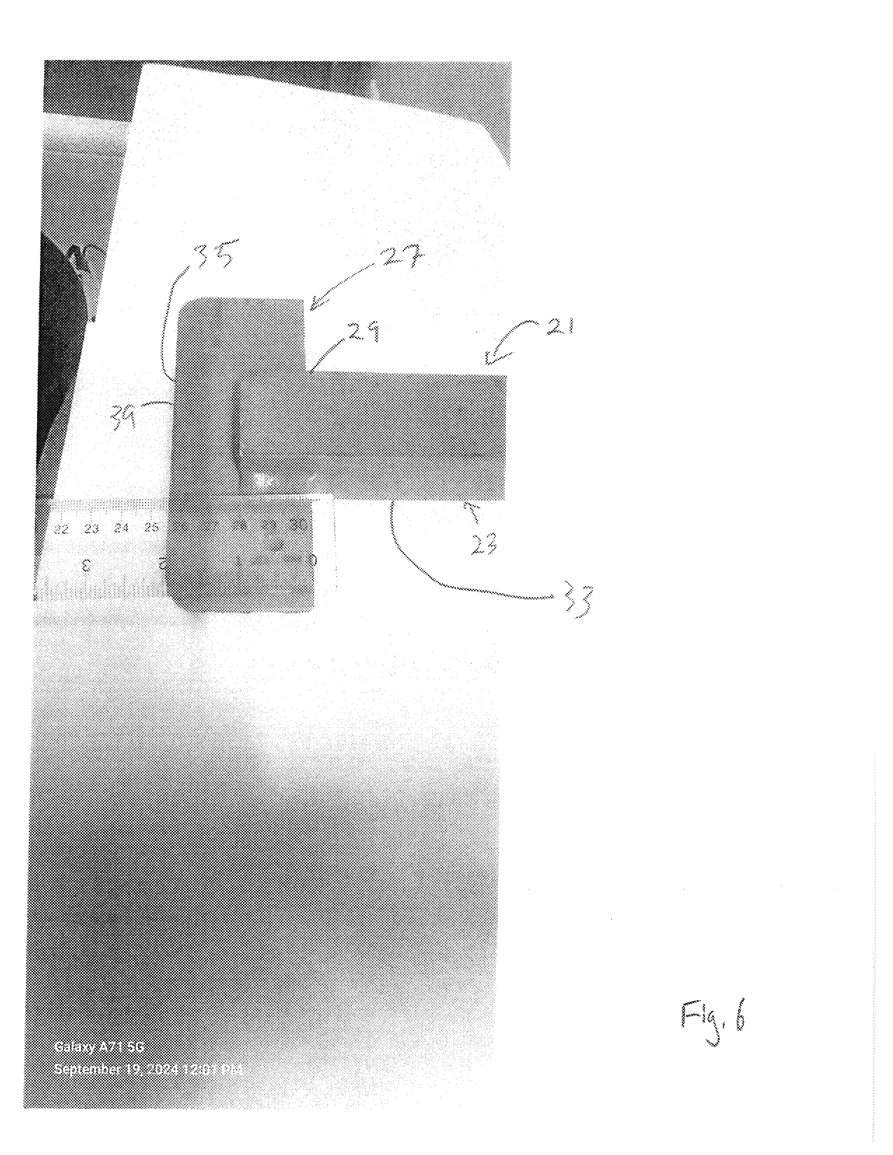

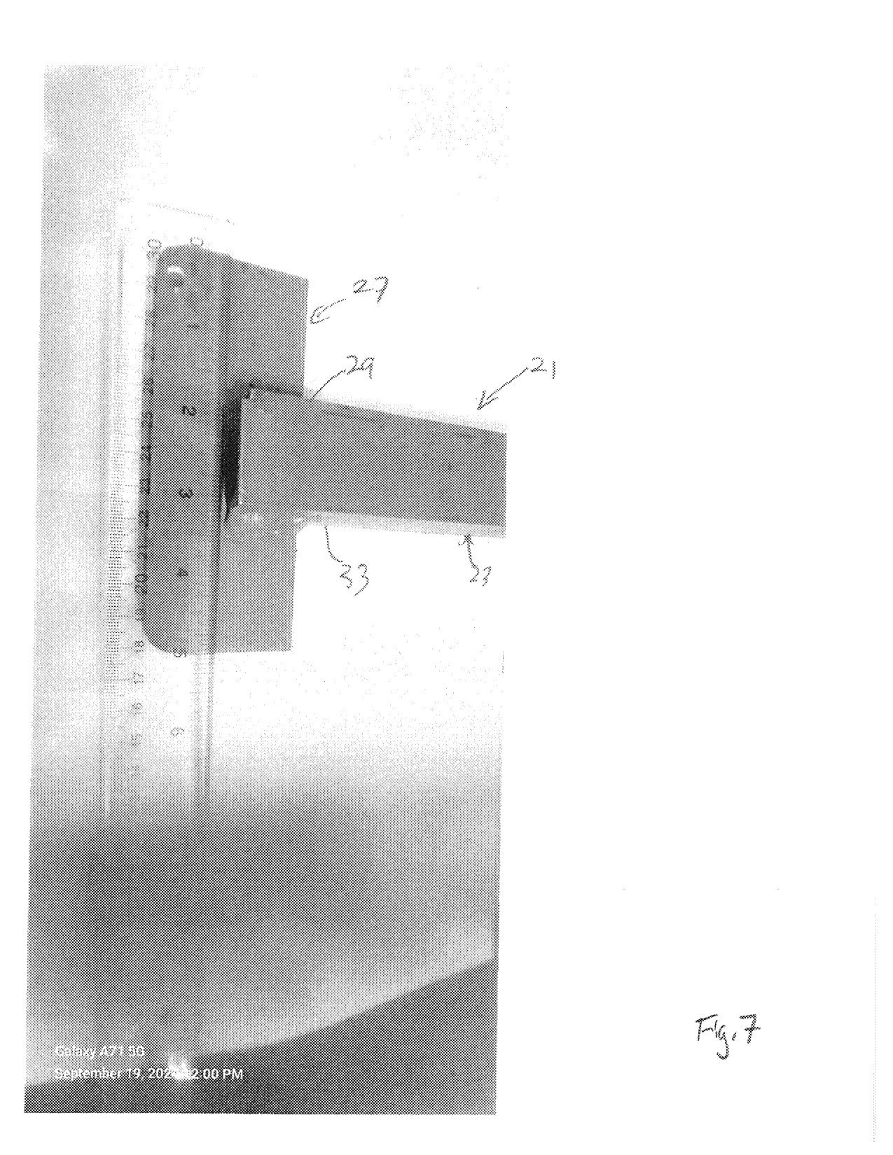

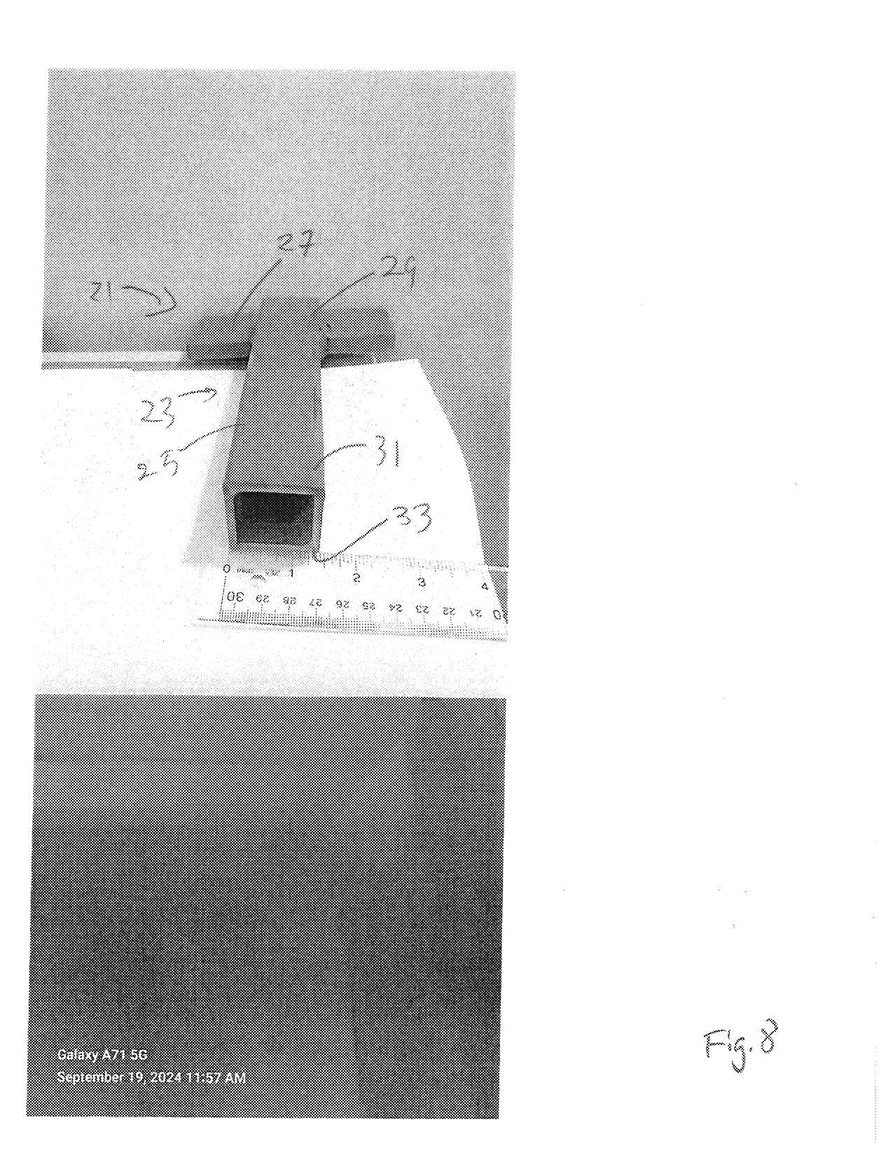

In the embodiment shown in FIGS. 1-8, a support 21 for a truck ramp tr is shown and described. In one suitable implementation, support 21 makes use of a pair of elements, such as elongated members 23 which are removably securable at the rear of the truck and adapted to engage an associated truck ramp tr.

Elongated members 23 have respective post members 25 and respective ramp flanges 27. Each of the post members 25 has respective upper and lower ends 29, 31. The ramp flanges 27 of elongated members 23 are connected at upper ends 29 of post members 25.

Lower ends 31 of post members 25 have respective, engagement portions 33 which are configured to engage the truck t at corresponding locations l (FIG. 1) proximate to the cargo area of truck t.

Ramp flanges 27 include respective support areas 35 oriented to engage a forward end of the truck ramp tr when it is deployed, and when the user desires to connect such truck ramp in operative position relative to the floor of the cargo area of the truck.

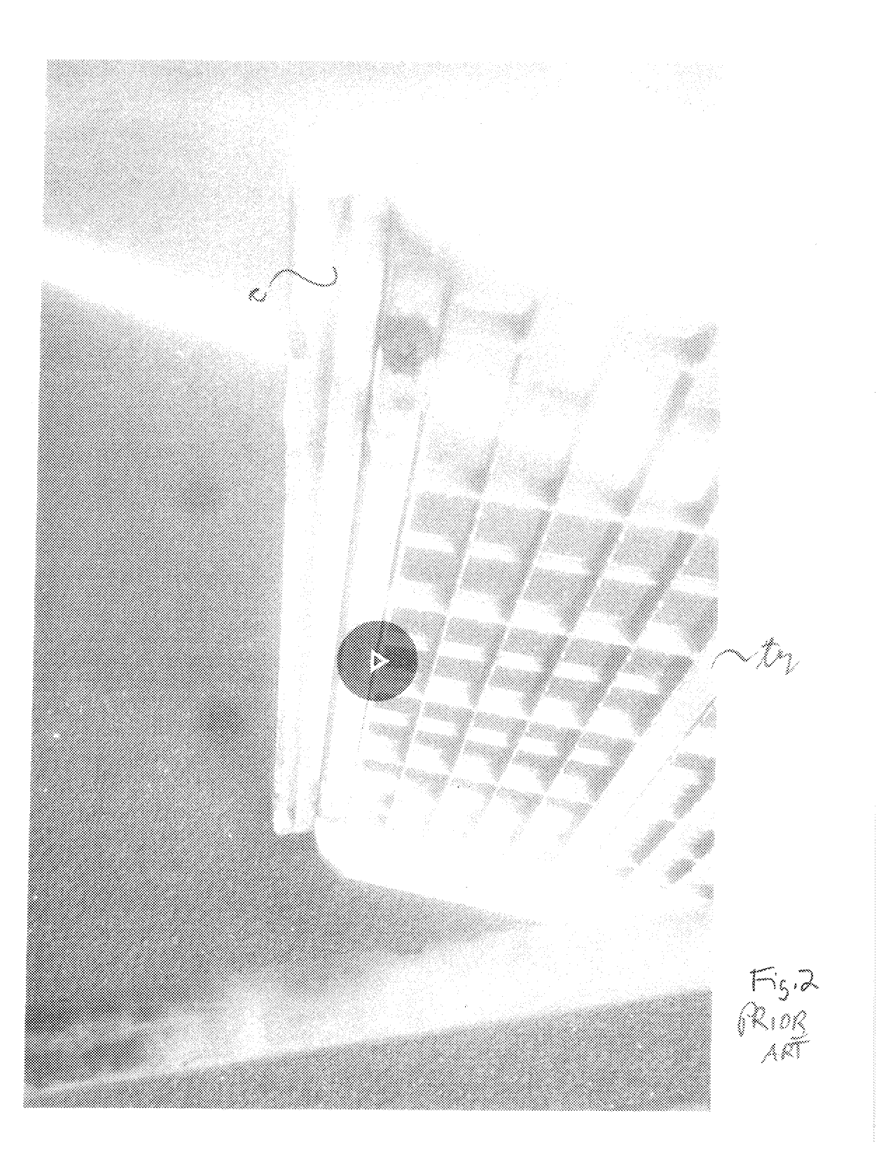

Support 21 for truck ramps may be adapted for use in any number of vehicles, including trucks of all kinds, such as semi-trucks or tractor trailers, flatbeds, or box trucks, or other vehicles making use of ramps. In one suitable configuration, the rear of the truck has a rearwardly facing surface and post members 25 in the illustrated implementation have respective forward faces 37 which may be brought flush against or into opposition against a corresponding rear surface of the truck and locations l. In this way, forward faces 37 of post members 25 distribute torque or other forces which may be transmitted between the truck ramp tr and the rear of the truck when the ramp is in use. As such, support 21 and its forward faces 37 mitigate forces which may otherwise tend to separate the forward end of the truck ramp tr from the rear of the truck when the ramp is deployed. Such forces also tend to wear out engaged components of the truck ramp itself or support members of the prior art, as shown in the ramp of FIG. 2, with damaged lower surface portions.

Again, noting that other configurations are possible, post members 25 may be slidably receivable in respective, corresponding, brackets b. Brackets b may be part of a kit associated with truck ramp support 21 or may be previously installed and associated with other, prior art supports. Such brackets b may be disposed at the rear of the truck and are sized to retain the previously described forward faces 37 against the rear surface of the truck to encourage the force resistance and force distribution described above, and to protect the corresponding portions of the ramp as discussed immediately above.

In certain implementations, support 21 is adapted for use when the forward end of the truck ramp tr has a lower ramp surface with a downwardly facing channel c defined therein when the truck ramp tr is deployed (FIG. 2). In such implementation, post members 25 may be securable at the rear of the truck so as to extend orthogonally and upwardly relative to the floor of the cargo area. As such, support areas 35 of ramp flanges 27 define tongues 39 which are sized or otherwise configured to removably engage channel c when the truck ramp tr is deployed.

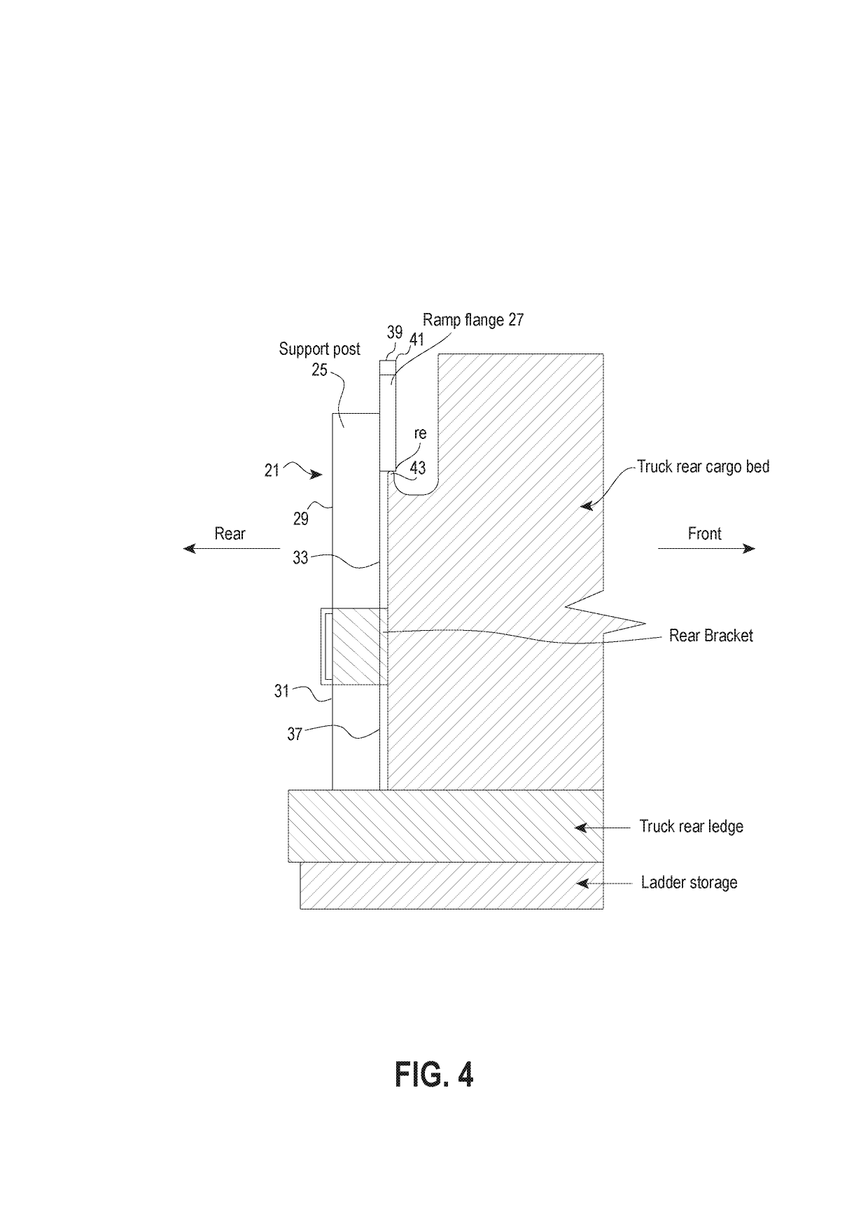

In certain truck configurations, the rear of the truck has an upwardly oriented rear edge re defined therein (FIGS. 1 and 4). The lower surface of the forward end of the truck ramp tr has a lower engagement surface defined therein. In such truck configuration, according to certain implementations, the support for the truck ramp 21 has each of its ramp flanges with opposite, upper and lower flange surfaces 41, 43. In this manner, upper flange surface 41 is configured to engage lower engagement surface at the forward end of the truck ramp tr, whereas lower flange surface 43 is configured to engage the rear edge re when post members 25 are secured at the rear of the truck (FIG. 4).

Ramp flanges 27 may assume any number of forms suitable to engage truck ramps tr. Ramp flanges 27 and may be fixed relative to post members 25 or movable relative thereto, so long as such ramp flanges 27 may selectively engage with corresponding portions of truck ramp tr. Accordingly, in the implementation illustrated in FIGS. 1-8, ramp flanges 27 are in the form of cross-pieces which are fixedly secured at upper ends 29 of respective post members 25. As such, these cross-pieces extend laterally from opposite sides of post members 25 to define respective, T-bars 45. In the T-bar configuration, accordingly, support areas 35 of ramp flanges 27 correspond to the upper surfaces of respective cross-pieces of the T-bars.

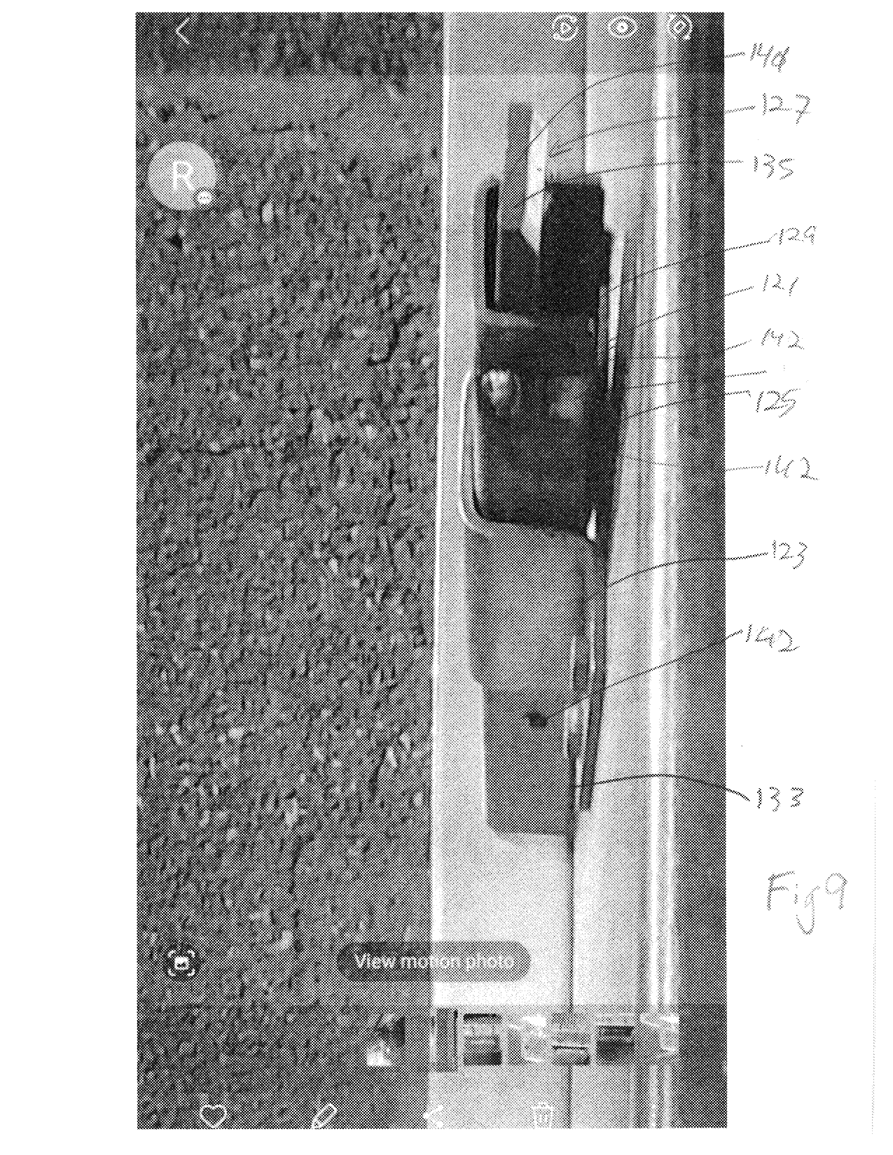

Other configurations of supports 21 and ramp flanges 27 are contemplated. For example, in FIG. 9, where like parts are ascribed like reference numerals in the 100 series, ramp flanges 127 illustrated in FIG. 9 are slidably mounted relative to respective ones of post members 125, so as to be securable at an extended position above the upper ends 129 of respective post members 125. The extended position at which slidable ramp flanges 127 may be secured may be predetermined so as to locate support areas 135 of the ramp flanges 127 relative to the rear of the truck and engage the forward end of truck ramp tr when deployed.

In the implementation shown in FIG. 9, upper ends 129 of post members 125 may be equipped with suitably located apertures 140. Ramp flanges 127 are slidably received and relatively fixable within apertures 140. Such apertures 140 extend from the upper ends 129 sufficiently longitudinally downwardly through post members 125 so as to receive ramp flanges 127 in both extended and retracted positions therein. To facilitate operation, that is, movement to extend or retract ramp flanges 127, suitable pins and grooves may be provided in opposing surfaces of ramp flanges 127 and post members 125, as indicated by reference 142 in FIG. 9.

Still further variations of ramp flanges 27, 127 and the configurations of support 21, 121 are contemplated, so as to engage rear portions of trucks and opposing portions of truck ramps tr. As such, the supports disclosed herein may be suitable for supporting truck ramps in which the truck comprises a tractor trailer truck and the cargo area is located in such trailer, as well as truck ramps in which the cargo area is merely a flatbed, as well as box trucks with a cargo area integral therein.

What is claimed is:

1. A support for a truck ramp, in which the truck ramp is user-deployable between a stowed position and a deployed position, the ramp having a forward end securable to a rear of the truck to facilitate access to the floor of a truck cargo area, the truck ramp support comprising
a pair of elongated members configured to engage a forward end of the truck ramp, each of the elongated members comprising a post member and a ramp flange, the post member having upper and lower ends, the ramp flange located at the upper end of the post member; and
an engagement portion at the lower end of the post member, the engagement portion configured to engage the rear of the truck at a location proximate to the cargo area of the truck;
wherein the ramp flanges include respective support areas oriented to engage the forward end of the ramp when the ramp is deployed.

2. The support of claim 1, in which the rear of the truck has a rearwardly facing rear surface, wherein the post members comprise respective forward faces opposable against the rear surface of the truck to distribute across the forward faces any torque or other forces which may be transmitted between the ramp and the rear of the truck ,which forces would otherwise separate the forward end of the ramp from the rear of the truck when the ramp is deployed

3. The support of claim 2, wherein the post members are slidably receivable in respective, corresponding, previously installed brackets disposed at the rear of the truck, the brackets sized to retain respective ones of the forward faces of the post members against the rear surface of the truck.

4. The support of claim 1, in which the forward end of the ramp as a lower ramp surface with a downwardly facing channel defined therein when the ramp is deployed,
wherein the post members are removably securable at the rear of the truck to extend vertically relative to the floor of the cargo area; and
wherein each of the support areas defines a tongue configured to removably engage the channel when the ramp is deployed.

5. The support of claim 2, in which the rear of the truck has an upwardly oriented rear edge defined therein, and in which the lower surface of the forward end of the ramp has a lower engagement surface defined therein;
wherein each of the ramp flanges have opposite, upper and lower flange surfaces, the upper flange configured to engage the lower engagement surface of the forward end the ramp, and the lower flange surface configured to engage the rear edge when the post members are secured at the rear of the truck.

6. The support of claim 1, wherein each of the ramp flanges comprises a cross-piece fixedly secured at the upper end of the post member and extending laterally from opposite sides of the post member to define a T-bar, the T-bar having an upper surface, the support area disposed on the upper surface of the T-bar to engage the forward end of the ramp when the ramp is deployed.

7. The support of claim 1, wherein each of the ramp flanges is slidably mounted to respective ones of the post members to be securable at an extended position above the upper end of the respective post member, the extended position predetermined to locate the support areas of the ramp flanges relative to the rear of the truck to engage the forward end of the ramp when the ramp is deployed.

8. The support of claim 7, wherein the upper ends of the post members have respective apertures defined therein and wherein the respective ramp flanges are received in respective apertures and slidable relative thereto.

9. The support of claim 8, wherein the apertures extend into respective post members from respective upper edges thereof, and wherein the ramp flanges are slidable to retracted positions in which the support areas are received in the apertures, and wherein the ramp flanges are slidably deployable to respective extended positions.

10. The support of claim 1, for supporting a truck ramp in which the truck comprises a tractor trailer truck and the cargo area is located in the trailer.

11. The support of claim 1, for supporting a truck ramp in which the truck comprises a flat-bed truck.

12. The support of claim 1, for supporting a ramp in which the truck compromises a box truck and the cargo area is located in the box portion of the truck.
